(19) United States
(12) Patent Application Publication
(10) Pub. No.: US 2006/0146658 A1
(43) Pub. Date: Jul. 6, 2006

(54) Memory storage handling system

(75) Inventor: Wray Russ, Modesto, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Microboards Technology, LLC, Chanhassen, MN (US)

(21) Appl. No.: 11/291,967

(22) Filed: Dec. 2, 2005

Related U.S. Application Data
(60) Provisional application No. 60/640,572, filed on Dec. 30, 2004.

(51) Int. Cl. G11B 21/08

(52) U.S. Cl. 369/30.01

(57) ABSTRACT

A memory storage system for cartridge encased mediums. The system includes a housing having at least one hopper for stacking a plurality of recordable mediums in a stack, each medium contained in a cartridge, a dispenser attached to the hopper for dispensing a medium from the hopper and a duplication system. The duplication system includes a plurality of drives for recording data onto the medium, and a carriage system for receiving the medium from the dispenser and moving the medium to one of the plurality of drives of the duplication system.

### CROSS REFERENCE TO RELATED APPLICATIONS

This application claims priority to U.S. Provisional Patent Application Ser. No. 60/640,572, filed Dec. 30, 2004, which is incorporated herein by reference in its entirety.

### FIELD OF THE INVENTION

This invention relates to a duplication system for dispensing mediums encased in a cartridge and particularly to systems for handling, printing, duplicating or replicating cartridge encased discs.

### BACKGROUND OF THE INVENTION

One of the most popular types of media is optical disks, such as compact disks and digital video disks, or digital versatile disks. The optical disk or CD has recently become a popular form of media for storing digital information, recording high quality audio and video information and for recording computer software of various types. With advances in technology, reading information from such optical media is now possible not only, but also to record digital information directly onto the media. For example, recordable compact disks (called CD-Rs) may have digital information recorded on them by placing the CD-R into a compact disk recorder that receives the digital information from a computer. Such forms of optical media are thus particularly useful for data distribution and archiving.

The standard compact disk typically does not include a cartridge or encasement for the optical disk. In disks for use with computer processors, they typically adapt the recording formats and content to the particular type of computer processor with which the disk is to operate. Some compact disks are recorded in such a way as to be usable with several different computer processor types, i.e., PC, Macintosh, etc. Disk handling systems typically move a single disk between a stack of disks and a workstation. Such systems are particularly useful for handling memory storage disks such as CD's, DVD's and the like. Common memory storage disk handling systems include data writers, label printers, or both.

They originally conceived the digital compact disk in the early 1980's as a technique to accurately copy and preserve audio recordings intended for sale to a mass market of consumers. As computing power has increased exponentially since then, information processing tasks unthinkable only a few years ago have become commonplace and require large amounts of data most economically and conveniently stored on digital compact disks. Until recently the transfer of data onto compact digital disks was a costly procedure economically feasible only when manufacturing a large quantity of copies. Users whose applications required relatively few copies or required frequent data updates could not reap the benefits of this technology, although low-cost disk-readers were readily available. The advent of recordable digital compact disks, generally referred to as “CD-R” disks, was intended to allow users to record their own disks and thereby achieve significant savings. Unlike a common compact disk that a mold has pressed, a CD-R has a dye layer etched by a laser contained in the CD-R disk drive. Once etched, the “burned” CD-R disk is unalterable and will retain data for approximately 75 years.

Despite their overall durability, compact disks are still prone to damage caused by improper handling. A compact disk is especially susceptible to surface scratches large enough to defeat the disk's internal error correction coding. Disks that are subject to large amounts of physical handling, either manually by humans or automatically by computer systems, are most vulnerable. In order to avoid this problem of the optical disk being damaged, the optical disk is encased in a cartridge or disk caddy that protects the compact disk while allowing an input or output device access to the surface of the disk. The cartridge or caddy is similar to a floppy disk case including a spring-loaded metallic sleeve that protects a section of the open face of the optical disk. Once inserted into a caddy-compatible disk read/write unit, the metallic sleeve is pushed away and input/output operations may be performed on the optical disk.

Typically, the cartridge or caddy for an optical disk is similar to a floppy disk case including a spring-loaded metallic sleeve that protects a section of the open face of the optical disk. Once inserted into a caddy-compatible disk read/write unit, the metallic sleeve is pushed away and input/output operations can be performed on the optical disk. Magnetic disks typically do not have a spring-loaded metallic sleeve, however, magnetic disk require the same or similar protection that is provided to an optical disk.

The storage capacity of an optical disk depends on the track pitch or size of the data on the disk and the wavelength of the laser used to read the optical disk. The typical wavelength of a red laser used in a DVD or CD is about 640 to about 650 nanometers (nm). A nanometer is one billionth of a meter. Thus, because of the need to increase storage capacity on optical disks, the computer industry is using lasers having different wavelengths.

It is anticipated that the next generation of large capacity optical disk video recording formats will use lasers having wavelengths of less than 500 nm. In a diode laser, as used in optical discs and laser printers, the type of material in the crystal that creates the laser light determines the wavelength and the color of laser light created. For example, the Blu-ray Disc™ uses a 405 nm blue violet laser that enables the recording, rewriting and play back of up to 27 gigabytes (GB) of data on a single sided single layer 12 cm CD/DVD size disk. In addition, by employing a short wavelength blue violet laser, the Blu-ray Disc can store up to 27 GB of density recording on a single sided disc. A single-sided, double layer Blu-ray Disc has up to 50 GB of density or storage capacity. With their storage capacity, Blu-ray Discs can hold and playback large quantities of high-definition video and audio, as well as photos, data and other digital content.

In addition, since the new generation disks use global standard “MPEG-2 Transport Stream” compression technology, the disc is highly compatible with digital broadcasting for video recording, a wide range of content can be recorded and it is possible for the new generation of disks to record digital high definition broadcasting while maintaining high quality and other data simultaneously with video data if they are received together.

The ability to store increased amounts of data on a disk and the susceptibility of the disk to damage will likely result in optical disks being encased in a cartridge or caddy to protect the optical disc's recording and playback phase from dust and fingerprints. Although, one cannot anticipate the cartridge size, it has been revealed that the Blu-ray Disc will have a cartridge with dimensions of approximately 129×131×7 mm, and the lomega® REV™ (magnetic) having a cartridge with dimensions of approximately 75×77×10 mm.

One of the anticipated problems with the Blu-ray Disc and other high density disks is the ability to record data and other information onto the disk in an efficient manner. For example, at 1× speed recording on a Blu-ray Disc, it is anticipated that with current technology that it will take about 1 hour 35 minutes for a full Blu-ray Disc (27 GB) to be copied. Although, it is anticipated that the time for copying will be significantly reduced with new technology, it will be imperative, that a duplication system be able to copy more than one medium at a time.

Since the s storage capacity on both optical and magnetic disks will grow tremendously over the next few years, it is imperative that disk duplication systems be able to reproduce and copy multiple disks in an efficient manner. Accordingly, what is needed is a duplication system that can duplicate a number of mediums in an efficient and cost effective manner.

In addition, while the typical single memory storage device systems are effective, users may desire more throughput, i.e., an increase in the number of mediums handled per hour, and less maintenance. Accordingly, what is desired is a reliable way of increasing the throughput of a medium handling system for cartridge or caddy-based.

### SUMMARY OF THE INVENTION

According to one aspect of the present invention, a memory storage system for cartridge encased mediums, the system includes a housing having at least one hopper for stacking a plurality of recordable mediums in a stack, each medium contained in a cartridge; a dispenser attached to the hopper for dispensing a medium from the hopper; a duplication system, the duplication system having a plurality of drives for recording data onto the medium; and a carriage system for receiving the medium from the dispenser and moving the medium to one of the plurality of drives of the duplication system.

In accordance with another aspect of the present invention, a memory storage system for cartridge encased disks, the system includes a housing having at least one hopper for stacking a plurality of recordable optical disks in a stack, each disk contained in a cartridge; a means for separating a disk from the stack; a duplication system, the duplication system having a plurality of drives for recording data onto the disk; and a carriage system for receiving the disk from the dispenser and moving the disk to one of the plurality of drives of the duplication system.

Still other objects, features, and attendant advantages of the present invention will become apparent to those skilled in the art from the reading of the following detailed description of embodiments constructed in accordance therewith, taken in conjunction with the accompanying drawings.

### BRIEF DESCRIPTION OF THE DRAWINGS

This invention will now be described in greater detail with reference to the preferred embodiments illustrated in the accompanying drawings, in which like elements bear like reference numerals, and wherein:

FIG. 1 is a perspective view of one embodiment of a duplication system for cartridge encased optical mediums according to the present invention.

FIG. 2 is a perspective view of a cartridge encased optical medium.

FIG. 3 is a side view of the duplication system of FIG. 1.

FIG. 4 is an end view of the duplication system of FIG. 1.

### DETAILED DESCRIPTION

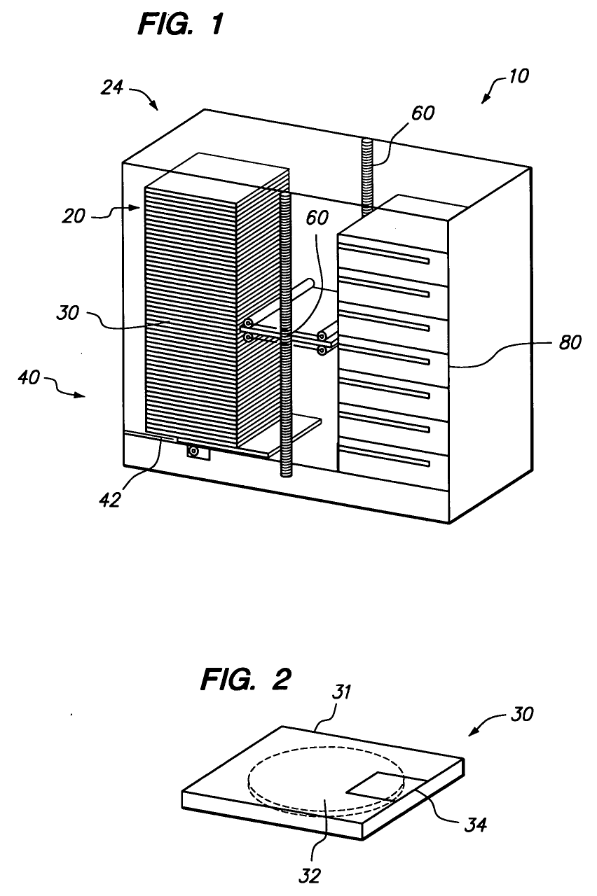

FIG. 1 shows a memory storage system for cartridge encased mediums, generally designated with the reference numeral 10. The system 10 includes a housing 20, a dispenser 40, a carriage system 60, and a duplication system 80.

The housing 20 includes at least one hopper 24 for holding a plurality of recordable mediums 30. The plurality of recordable mediums 30 are preferably cartridge 31 encased disks 32. The encased disks 32 are preferably optical, however, the disks can be magnetic or any other readable disk. It can be appreciated that the recordable mediums can also include electronic memory cards, including CompactFlash, SmartMedia, Memory Stick, PCMCIA Type I and Type II memory cards, memory cards for video game consoles and the like.

The housing 20 includes a hopper generally designated with the reference numeral 24. The hopper 24 functions to hold a plurality of memory storage mediums in a stack, and more preferably a vertical stack. In one embodiment, a plurality of posts define the hopper 24 and provide a light weight structure to guide the mediums 30. However, one can appreciate that hopper 24 may assume any of a number of configurations. The hopper 24 provides a means for retaining the mediums 30 in a stack. The feed hopper 24 is generally designed to hold between 25 and 150 mediums depending on the size of the system 10. However, it can be appreciated that the system 10 can be designed with or without the feed hopper 24. If a feed hopper 24 is not utilized, the mediums 30 can be loaded by a conveyor belt system or other known method for feeding a plurality of mediums to the carriage system 60.

As shown in FIG. 2, the cartridge 31 protects the optical disk 32 while allowing an input or output device access to the surface of the optical disk. Specifically, the disk cartridge 31 protects the optical disc's recording and playback phase from dust and fingerprints. In one embodiment the cartridge 31 has a spring loaded metallic sleeve 34 that protects a section of the open face of the disk. Once inserted into a duplication system 10, the metallic sleeve 34 is pushed away and the input/output operations performed by the duplication system 10 can be performed on the optical disk 32. It can be appreciated that other means of accessing the cartridge 31 encased disk can be utilized without departing from the present invention.

In one embodiment, the cartridge 31 has a substantially rectangular shape. For example, the Blu-ray Disc may be a cartridge encased optical disk having dimensions of about 129 mm (length)×131 mm (width)×7 mm (height). The Blu-ray Disc has a diameter of about 120 mm, and a disk thickness of about 1.2 mm including an optical transmittance protection layer or about 0.1 mm. However, the dimensions of the cartridge can vary according to the diameter and thickness of the optical disk. In addition, it can be appreciated that the cartridge 31 can be rectangular, square or circular without departing from the present invention.

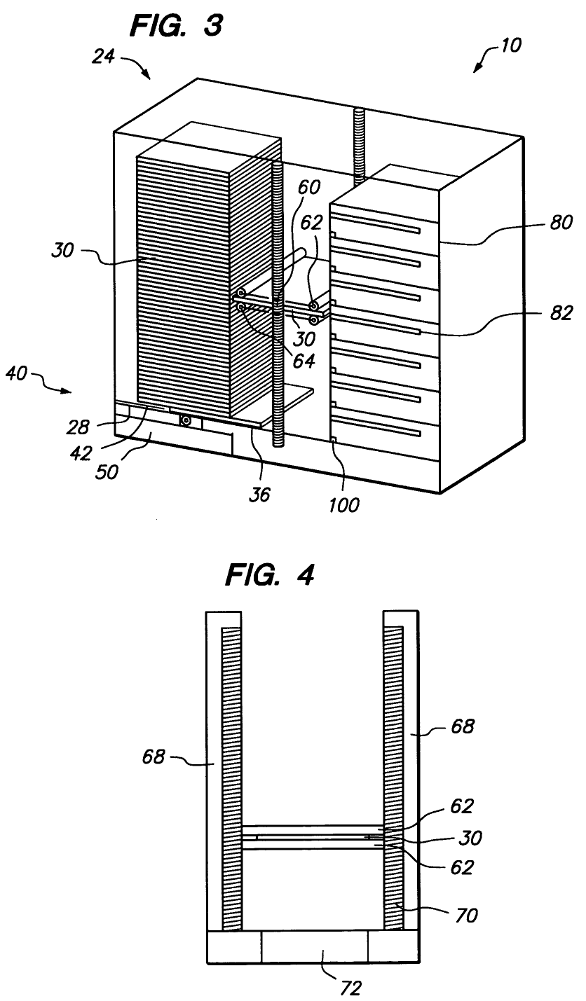

As shown in FIG. 3, the dispenser 40 for displacing the lower-most medium 36 from the hopper 24 in a vertical stack is positioned adjacent to the lower-most medium 36. The dispenser 40 preferably includes a pusher 42 and a motor assembly 50. The pusher separates the lower-most medium 36 from the stack of mediums 30. As shown in FIG. 3, the pusher 42 horizontally displaces the lower-most medium 36 from a stack of mediums 30. The pusher 42 engages an outer edge of the lower-most medium 36 and horizontally displaces the lower-most medium 36. The lower-most medium 36 moves from a position which is aligned with the stack of mediums 30 and supported by a medium support base 28 of the hopper 24 to the carriage system 60.

The pusher 42 separates at least one medium 30 from the stack of mediums and can be designed to separate two or more mediums 30 at a time. The pusher 42 displaces the lower-most medium 36 and any adjacent medium 30 from the stack of mediums 30 by engaging the outer edges of the lower-most medium 36 and adjacent mediums 30 up to the number of mediums 30 to be dispensed.

The pusher 42 will preferably have a uniform thickness which is equal to or slightly smaller the thickness of the lower-most medium 36. The thickness of the pusher 42 can approximate the thickness of an individual medium 30 to be dispensed so that when the pusher 42 slides the lower-most medium 36 is dispensed. If more than one medium 30 is being separated the pusher 42 can have a thickness equal to or slightly smaller than the number of mediums 30 being separated.

A motor assembly 50 controls the pusher 42. The motor assembly 50 includes a motor and mechanical linkage assembly including a gear system. Preferably, the motor is a servomotor that reciprocates the gear system to precisely move the pusher 42 in-and-out or forward and back. It can be appreciated that the motor assembly can include and type of motor, however, a servomotor is preferable because of the servomotor's ability to operate in short and uniform movements. The servomotor can be attached to the pusher 42 through a mechanical linkage assembly. In addition, the servomotor reciprocates a gear system to precisely move the pusher in-and-out or forward and back. It can be appreciated that the mechanical linkage assembly can include a plurality of gears, arms or other mechanisms to control the in-and-out motion of the pusher 42.

The carriage system 60 includes at least one pair of rollers 62, and more preferably at least two pairs of rollers 62 for receiving the medium 30 from the dispenser 40. In operation, the pusher 42 displaces the lower-most medium 36 from the stack of mediums 34 to the carriage system 60. The at least one pair of rollers 62 of the carriage system 60 accepts the lower-most medium 36 from the stack and positions the medium 30 between the at least one pair of rollers 62 as shown in FIG. 3. The carriage system 60 then transports the medium 30 to the duplication system 80. The duplication system 80 preferably has a plurality of disk drives 82 for writing data onto to the medium 30.

The at least one pair of rollers 62 rotate in a clockwise or counter clockwise direction to accept or discharge the medium 30. The at least one pair of rollers 62 receives the medium 30 from the dispenser 40. The direction of rotation of the at least one pair of rollers 62 is a function of the position of roller and the direction of acceptance or discharge of the medium 30. The carriage system 60 transports the medium 30 to one of the plurality of disk drives 82. At least one sensor 100 controls the location of the carriage system 60 as the carriage system 60 receives and discharges the medium 32. The at least one pair of rollers 62 rotate in a clockwise or counterclockwise direction to discharge the medium 32 to at least one of the disk drives 82 of the duplication system 80. Once the data or other media has be written or recorded on the medium 32, the duplication system 80 ejects the medium 32 and the carriage system 60 and the at least one pair of rollers 62 reverse the process and receives the medium from the duplication system 80.

In one embodiment, the at least one pair of rollers 62 of the carriage system 60 include at least one pinch roller 64. The at least one pinch roller 64 can be powered by a microprocessor that causes at least one pinch roller 64 to drop down and exert pressure on the cartridge 31 placed between the at least one pair of rollers 62. The pressure increases the friction between the pinch roller 64 and the cartridge 31, and upon activation the at least one pair of rollers 62 in combination with the pusher 42 receives the lower-most cartridge encased medium 32 from the hopper 24. The carriage system 60 then transports the cartridge encased medium 32 from the dispenser 40 to the duplication system 80.

As shown in FIG. 4, the carriage system 60 also includes a pair of carriage walls 68, a drive system 70 and a motor 72. The carriage system 60 is held in position by a pair of carriage walls 68. The drive system 70 can be a belt driven system having a plurality of belts for oscillating the carriage system 60 from receiving the medium and transferring the medium to one of the plurality of disk drives 82. One skilled in the art will be able to recognize a number of alternative configurations, including rails, rollers and bearings, screw driven or cable driven system is suitable for permitting relative movement of the carriage with respect to the duplication system including a guiding means. The carriage system 60 is preferably driven by a reciprocating means mounted in part within the housing. The movement of the carriage is confined to oscillate within a region defined by the carriage walls. In one embodiment, the carriage system 60 is mounted or coupled to a screw-driven rotating threaded shaft, not unlike those routinely found in floppy and hard disk drives as well as CD-ROM drives. The screw-driven shaft provides precision positioning of the carriage system 60 by rotating the threaded shafts a predetermined number of revolutions under the control of a suitable drive mechanism. As the shafts are rotated, a plurality of matching threaded couplers are fixed to the at least one pair of rollers 62. The threaded couplers cause the at least one pair of rollers 62 to transport the cartridge encased medium 30 a specified distance. The direction of the threaded shaft rotation and the number of turns controls the distance and direction of the movement of the at least one pair of rollers 62.

In another embodiment, the drive system 70 includes a linkage assembly having a plurality of belts and pulleys. The linkage assembly includes a plurality of pulleys and drive belts to move the carriage system 60. In addition, it can be appreciated that a geared linkage assembly can be substituted in accordance with the present invention for the pulley mechanism, or the cam mechanisms disclosed herein. The motor actuates a mechanical linkage to cause the belt system to lift the at least one pair of rollers 62 from a first position to a second position.

In operation, the carriage system 60 can remain in a first position until the user causes the carriage system 60 to begin operation. The carriage system 60 oscillates from the first position to a plurality of positions for loading and receiving the cartridge encased medium from the duplication system. At least one sensor 100 located on the carriage system 60 and the duplication system 80 control the movement of the carriage system 60 from receiving the cartridge encased medium 30 from the dispenser 20 to transferring the cartridge 31 to one of a plurality of disk drives 82 of the duplication system 80.

The sensors 100 can be an optical proximity sensor, a micro-switch, a flag sensor, a capacitive sensor, an inductive sensor, a magnetic read switch or any other sensor known to one skilled in the art which recognizes the presence of the carriage system including the medium.

In operation, the sensor 100 sends a signal to a microprocessor to begin the process of receiving the medium 30 from the dispenser 40 and transferring the medium 30 via the carriage system 60 to one of the plurality of disk drives 82. Once the recording process has been completed, if appropriate, the microprocessor sends another signal to the carriage system 60 to retrieve the medium 30 and transfer the medium to a receptacle. In addition, the microprocessor controls the movement of the carriage system 60 such that the mediums 30 are dispensed into the carriage system 60 at the correct intervals.

The duplication system 80 preferably includes a plurality of disk drives 82 having a means for recording data onto the cartridge encased medium 30. The disk drive 82 includes read/write heads, a drive motor, a stepper motor, a mechanical frame and a circuit board. The read/write heads are located on both sides of the disk, and move together on the same assembly. The heads are not directly opposite each other in an effort to prevent interaction between the write operations on each side of the two media surfaces. The same head is used for reading and writing, while a second, wider head is used for erasing a track just prior to it being written. This allows the data to be written on a wider “clean slate,” without interfering with the analog data on an adjacent track. A very small spindle motor engages the metal hub at the center of the diskette, spinning it at either 300 or 360 rotations per minute. The stepper motor makes a precise number of stepped revolutions to move the read/write head assembly to the proper track position. The read/write head assembly is fastened to the stepper motor shaft. The mechanical frame is a system of levers that opens the little protective window on the diskette to allow the read/write heads to touch the dual sided diskette media. An external button allows the diskette to be ejected, at which point the spring-loaded protective window on the diskette closes. The circuit board contains all of the electronics to handle the data read from or written to the diskette. It also controls the stepper-motor controls circuits used to move the read/write heads to each track, as well as the movement of the read/write heads toward the diskette surface.

The duplication system 80 can also include recordable drives, medium writers or any other known optical medium duplication system. In a preferred embodiment, the plurality of disk drives 82 are arranged in a stack for receiving a plurality of mediums 30. The duplication system 80 preferably has the ability to record a plurality of mediums 30 simultaneously for increased productivity. Typically, the amount of time needed to transfer a quantity of data to a medium is a function of the amount of data and the rate at which the disk drives and recordable drivers are able to transfer the data.

The system 10 preferably connects to a computer network, or to a stand-alone computer via a standard connection such as a network card and cable, or a serial cable, respectively, so that data, which is to be duplicated, can be communicated to the system 10.

In one embodiment, when the data is written, the carriage system 60 removes the mediums 30 from the plurality of disk drives 82 and places the mediums 32 in a receptacle (not shown). Alternatively, in another embodiment, the carriage system 60 returns the medium 32 to the hopper 24. As shown in FIGS. 3 and 4, the carriage system 60 transports the lower-most medium 36 from the stack of mediums 34 to the duplication system 80. Once data has been written on the medium 32, the medium 32 is ejected from the duplication system 80 to the carriage system 60. The carriage system 60 then transports the medium 32 to the top of the system 60, wherein the rollers 62 rotate in a clockwise or counterclockwise direction to place the medium 32 onto the top of the stack of mediums 34. Preferably, the system 10 is configured to duplicate or copy a plurality of mediums 32. Accordingly, the system can include a blank or other suitable mechanism to indicate that data has been written or added to each of the mediums 32 within the stack of mediums 34. This sequence repeats until a defined number of mediums 32 have been recorded or the stack of mediums 32 have been depleted. It can also be appreciated that the system 10 can independently be designed to function as a standalone duplication or printing apparatus.

It can be appreciated that the medium recorders are but one example of a workstation type, which can be used in accordance with the present invention. For example, the medium recorders may be replaced with medium printers, medium cleaners, medium surface testing devices and other useful devices in accordance with the present invention.

The dispenser as shown in FIGS. 1-4 is useful in conjunction with recording data on memory storage mediums such as the Blu-ray Disc, Red-ray, or any other disk or medium system having an encased or cartridge encased medium or disk. It can be appreciated, however, that a variety of media including optical or magnetic memory storage media may be dispensed and duplicated in accordance with the present invention.

The system 10 can also include a loader board, a copy board, and/or a hard medium drive to assist the system in dispensing the medium onto the carriage system 60 and transferring the data to the medium 30. The hard medium drive couples with the medium writer to deliver data to be written on the lower-most medium 36. A controller or loader board, including a circuit board within the system 10 regulates operation of the hard medium drive, the copy board and the mechanical linkage for controlling the operation of the pusher 42, the carriage system 60 and the duplication system 80.

The dispenser of the present invention is useful in conjunction recording data on cartridge encased memory storage mediums, such as Blu-ray Discs. However, it can be appreciated, that a variety of media including optical or magnetic memory storage media may be dispensed and duplicated in accordance with the present invention.

While the invention has been described in detail with reference to the preferred embodiments thereof, it will be apparent to one skilled in the art that various changes and modifications can be made and equivalents employed, without departing from the present invention.

What is claimed is:

1. A memory storage system for cartridge encased mediums, comprising:
a housing having at least one hopper for stacking a plurality of recordable mediums in a stack, each medium contained in a cartridge;
a dispenser attached to the hopper for dispensing a medium from the hopper;
a duplication system, the duplication system having a plurality of drives for recording data onto the medium; and
a carriage system for receiving the medium from the dispenser and moving the medium to one of the plurality of drives of the duplication system.

2. The system of claim 1, wherein the cartridge is substantially rectangular.

3. The system of claim 1, wherein the carriage system includes at least one pair of rollers for accepting the medium from the dispenser and transporting the medium to the duplication system.

4. The system of claim 1, wherein the carriage system includes at least one sensor for positioning of the carriage system relative to the dispenser and the plurality of drives of the duplication system.

5. The system of claim 3, wherein the at least one pair of rollers includes at least one pinch roller.

6. The system of claim 1, wherein the medium is an optical disk.

7. The system of claim 1, wherein the medium is a magnetic disk.

8. The system of claim 1, wherein the duplication system includes a hard drive.

9. The system of claim 1, wherein the system is a standalone duplication system.

10. The system of claim 1, further comprising a means for conveying the cartridge from the carriage to a storage receptacle.

11. The system of claim 10, wherein the storage receptacle is a second hopper for stacking the plurality of mediums in a stack.

12. The system of claim 1, further comprising a pusher for separating at least one medium from the stack of mediums.

13. A memory storage system for cartridge encased disks, comprising:
a housing having at least one hopper for stacking a plurality of recordable optical disks in a stack, each disk contained in a cartridge;
a means for separating a disk from the stack;
a duplication system, the duplication system having a plurality of drives for recording data onto the disk; and
a carriage system for receiving the disk from the dispenser and moving the disk to one of the plurality of drives of the duplication system.

14. The system of claim 13, wherein the means for separating the disk is a pusher for separating at least one disk from the stack.

15. The system of claim 13, wherein the cartridge is substantially rectangular.

16. The system of claim 13, wherein the carriage includes at least one pair of rollers for accepting the disk from the dispenser and transporting the disk to the duplication system.

17. The system of claim 16, wherein the at least one pair of rollers includes at least one pinch roller.

18. The system of claim 13, wherein the recordable disk is an optical disk.

19. The system of claim 13, wherein the recordable disk is a magnetic disk.
